(19) United States
(12) Patent Application Publication
(10) Pub. No.: US 2024/0133546 A1
(43) Pub. Date: Apr. 25, 2024

(54) LUMINOUS HELMET

(71) Applicant: Banglin Li, Shenzhen (CN)

(72) Inventor: Banglin Li, Shenzhen (CN)

(21) Appl. No.: 18/534,933

(22) Filed: Dec. 11, 2023

(30) Foreign Application Priority Data
Dec. 22, 2022 (CN) 202223469002.4

(51) Int. Cl. F21V 33/00; F21V 23/04

(52) U.S. Cl. CPC F21V 33/0008; F21V 23/04; F21Y 2115/10

(57) ABSTRACT

The present disclosure discloses a luminous helmet, and particularly relates to the technical field of helmets. The luminous helmet includes a main body, a housing is arranged above the main body, the housing is made of a semitransparent or transparent material, and at least one switch button is arranged on the housing; a lining is arranged below the housing, a plurality of mounting grooves are formed in a surface part of the lining, light-emitting elements are installed in the plurality of mounting grooves, and lamp beads are welded to the light-emitting elements; and the lamp beads are arranged to be multi-color LED lamp beads.

### TECHNICAL FIELD

The present disclosure relates to the technical field of helmets, and particularly relates to a luminous helmet.

### BACKGROUND

Helmets include safety helmets, cycling helmets, skating protective helmets, outdoor sports helmets and the like. These helmets are adaptive devices having a basic function of protecting users' head safety, and are used by people in daily life.

However, in actual use, ordinary helmets have no function of night warning. In particular, people who work at night, such as delivery guys, construction workers, cyclists and DiDi drivers, may wear luminous helmets in addition to clothes that can glow at night, to warn passing vehicles on the road more effectively, so as to avoid safety accidents.

However, most of the current helmets are non-luminous products, and some of them are luminous products, due to the design of less luminous positions and less use scenarios for luminous warnings, need to be improved in use.

### SUMMARY

In order to overcome the above defects in the prior art, the embodiments of the present disclosure provide a luminous helmet to solve the problems in the background above.

In order to achieve the above objective, the present disclosure provides the following technical solution: a luminous helmet, includes a main body, a housing, a lining, a switch button, a control panel, light-emitting elements, mounting grooves, a slot, a MCU chip and lamp beads, where the housing is arranged above the main body, the housing is made of a semitransparent or transparent material, and at least one switch button is arranged on the housing;
the lining is arranged below the housing, one or more mounting grooves of any shape are formed in a surface part of the lining, the light-emitting elements are installed in the plurality of mounting grooves, and the lamp beads are welded to the light-emitting elements;
the lamp beads are arranged to be multi-color LED lamp beads;
the number of the lamp beads is one or more;
the slot is further formed on the lining, a control panel and a storage battery are installed in the slot, and the storage battery is installed under the control panel;
an upper surface of the control panel is provided with the MCU chip; and

The switch button, the light-emitting elements and the storage battery are all electrically connected to the MCU chip on the control panel, and by pressing the switch button, the lamp beads on the light-emitting elements can be switched on and off, color and brightness of light can be adjusted, and light modes can be switched.

In a preferred embodiment, the switch button is configured to be one of a touch switch, a push switch, a hydraulic switch or a knob switch.

In a preferred embodiment, the mounting grooves on the lining are specifically arranged vertically, horizontally or obliquely.

In a preferred embodiment, the light-emitting elements are in fit with the mounting grooves on the lining.

In a preferred embodiment, the main body may be configured as a structure of any shape.

In a preferred embodiment, the switch button can be further arranged on either side of a bottom surface part or the surface part of the housing.

In a preferred embodiment, the switch button can be further arranged on either side of the surface part or the bottom surface part of the lining.

In a preferred embodiment, both the control panel and the storage battery are both in fit with the slot.

In a preferred embodiment, the lamp beads can be further configured as single-color LED lamp beads.

In a preferred embodiment, the light-emitting elements can be further embedded on the surface part of the housing or on either side of the bottom surface part of the housing.

The present disclosure has the following beneficial effects and advantages.

The present disclosure, by arranging a semitransparent or transparent housing, installing a plurality of the light-emitting elements on a surface of the lining inside the housing, installing a plurality of multi-color lamp beads on the light-emitting elements, and using the switch button and the MCU chip to control switching on/off of the lamp beads, light color adjustment and light mode switching, realizes the diversification of the helmet and the application in a plurality of usage scenarios, enables stronger safety warning, has a cooler appearance, meets the needs of different users, and is very practical.

### BRIEF DESCRIPTION OF THE DRAWINGS

FIG. 1 is an exploded diagram of an overall structure of the present disclosure.

FIG. 2 is a schematic diagram of a structure of a lining in the present disclosure.

FIG. 3 is a schematic diagram of a partially enlarged structure of a lining in the present disclosure.

FIG. 4 is an overall rear view of the present disclosure.

FIG. 5 is a schematic diagram of a structure of a control panel of the present disclosure.

FIG. 6 is a schematic diagram of a structure of a light-emitting element of the present disclosure.

Reference numerals in the accompanying drawings: 1. main body, 11. housing, 12. lining, 13. switch button, 14. control panel, 15. light-emitting element, 121. mounting groove, 122. slot, 141. MCU chip, 151. lamp bead.

### DETAILED DESCRIPTION OF THE EMBODIMENTS

The technical solutions in the embodiments of the present disclosure will be clearly and completely described below in combination with the accompanying drawings in the embodiments of the present disclosure. Apparently, the embodiments described are merely some rather than all of the embodiments of the present disclosure. Based on the embodiments of the present disclosure, all other embodiments obtained by those of ordinary skill in the art without making creative efforts shall fall within the protection scope of the present disclosure.

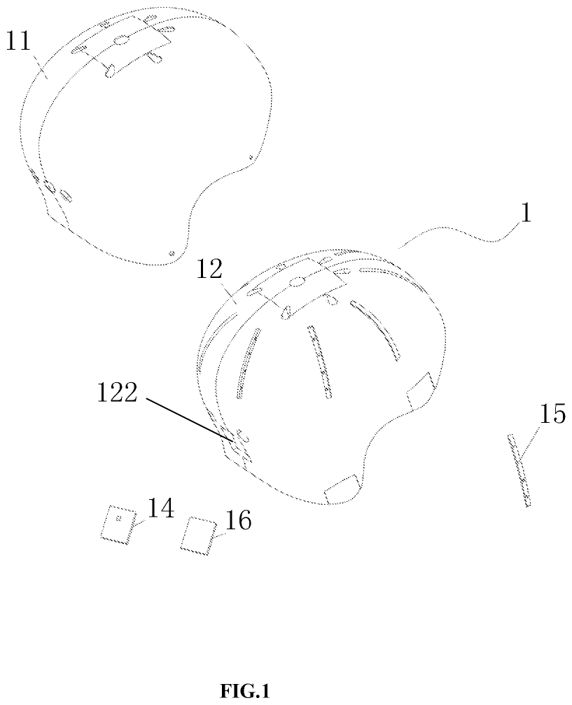

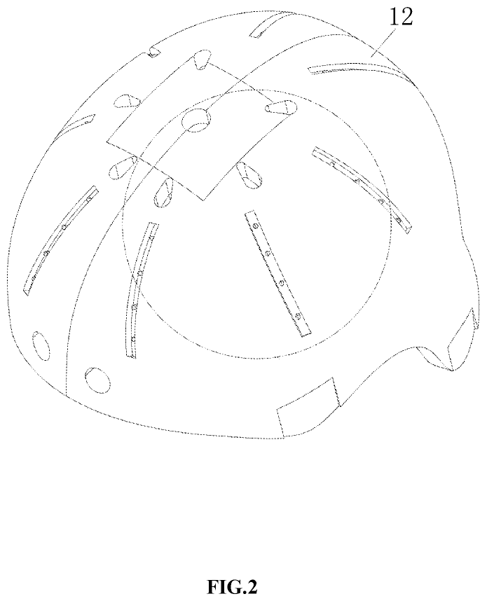

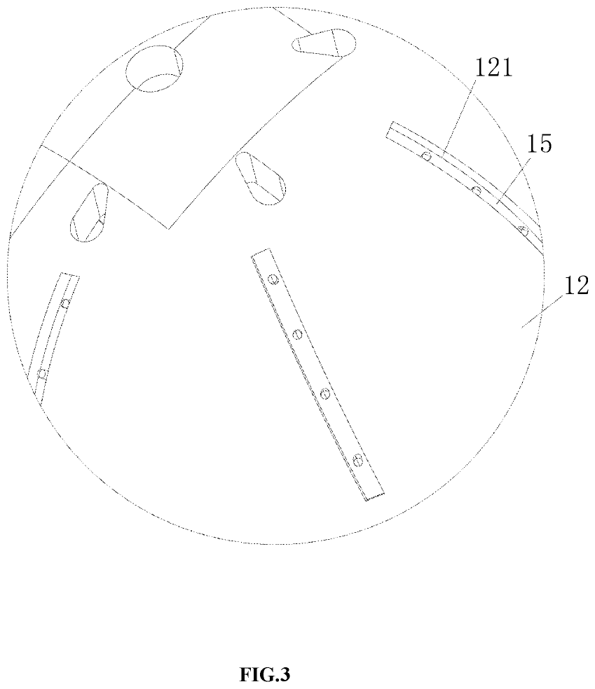

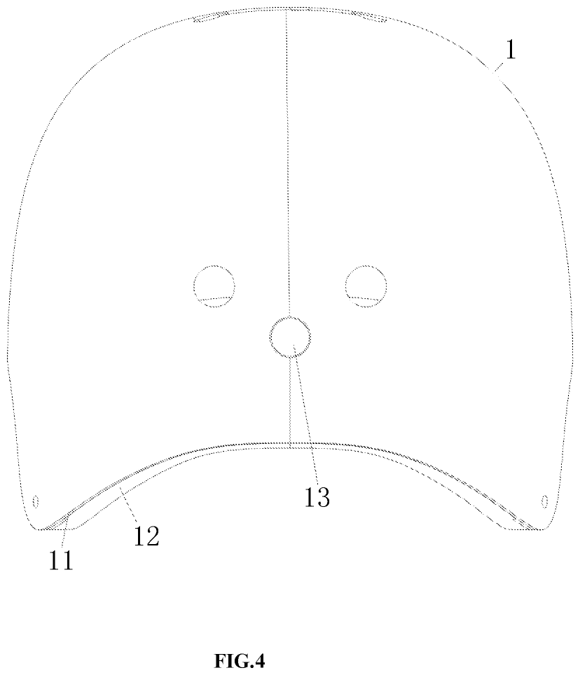

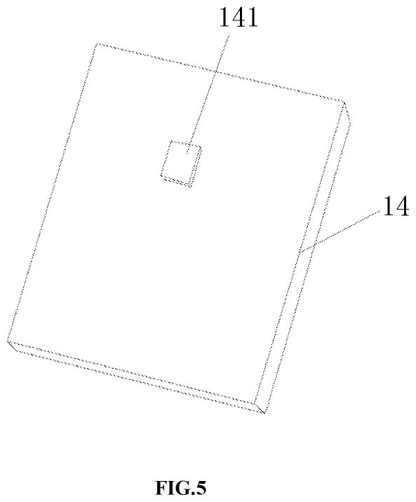

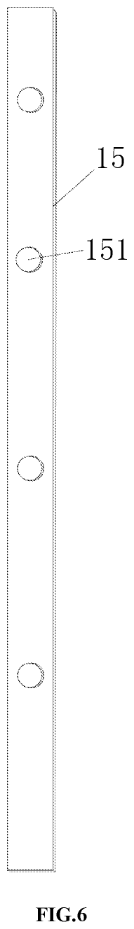

A luminous helmet as shown in FIGS. 1-6, includes a main body 1, a housing 11, a lining 12, a switch button 13, a control panel 14, a light-emitting element 15 and a storage battery 16, where the housing 11 is arranged above the main body 1, the housing 11 is made of a semitransparent or transparent material, at least one switch button 13 is arranged on the housing 11, and the switch button 13 is arranged on one side of a surface part of the housing 11; the lining 12 is arranged below the housing 11, one or more mounting grooves 121 of any shape are formed in a surface part of the lining 12, light-emitting elements 15 are installed in the plurality of mounting grooves 121, lamp beads 151 are arranged on the light-emitting elements 15, and the light-emitting elements 15 specifically refer to lamp panels, LED strips or string lamps with certain flexibility; the lamp beads 151 are arranged to be multi-color LED lamp beads; the number of the lamp beads 151 is one or more; a slot 122 is further arranged on the lining 12, a control panel 14 and a storage battery 16 are installed in the slot 122, and the storage battery 16 is installed under the control panel 14; an upper surface of the control panel 14 is provided with a MCU chip 141; and the switch button 13, the light-emitting elements 15 and the storage battery 16 are all electrically connected to the MCU chip 141 on the control panel 14, and by pressing the switch button 13, the lamp beads 151 on the light-emitting elements 15 can be switched on and off, color and brightness of light can be adjusted, and light modes can be switched.

In this embodiment, the mounting grooves 121 on the lining 12 are long-strip shaped grooves or line-shaped grooves, and the mounting grooves 121 on the lining 12 are specifically arranged vertically, horizontally or obliquely.

In some embodiments, the switch button 13 is configured to be one of a touch switch, a push switch, or a knob switch. The switch button 13 can be further arranged on either side of a bottom surface part or the surface part of the housing 11, and the switch button 13 can be further arranged on either side of the surface part or the bottom surface part of the lining 12, so that it is adapted to more usage scenarios and better assembly methods.

Further, the light-emitting elements 15 are in fit with the mounting grooves 121 on the lining 12. Each light-emitting element 15 is laid at the bottom of a mounting groove 121 or arranged on two side walls of the mounting groove 121. The light-emitting element 15 is fixed to the mounting groove 121 with glue to prevent the light-emitting element 15 from shaking. Both the control panel 14 and the storage battery 16 are both in fit with the slot 122.

Further, the main body 1 may be configured as a structure of any shape to meet market demand for helmets of different shapes and styles.

In some embodiments, the lamp beads 151 are also arranged to be single-color LED lamp beads, and the light-emitting elements 15 can be further embedded on the surface part of the housing or on either side of the bottom surface part of the housing 11.

When using this embodiment, a user only needs to press the switch button 13 on the housing 11 to turn on the lamp beads 151 installed on the light-emitting elements 15 inside the housing 11, and by means of the switch button 13, can further adjust the brightness and color of the lamp beads 151 and switch the light modes, such as an outdoor warning mode (red/yellow light flashes, or red/yellow light is always on) and an outdoor sports mode (multi-color lights flash alternately or are always on to add ambience).

The working principle of the present disclosure:

The present disclosure is mainly composed of the housing 11, the lining 12, the switch button 13, the control panel 14, the light-emitting elements 15, the MCU chip 141 and the lamp beads 151, where the housing 11 is fixed on the lining 12 by means of glue and screws, the switch button 13 is installed on the surface part of the housing 11, the MCU chip 141 is welded on the control panel 14, the MCU chip 141 is electrically connected to the control panel 14, the control panel 14 is installed in the matching slot 122, one or more lamp beads 151 are welded and fixed on the light-emitting elements 15, the light-emitting elements 15 are installed in the matching mounting grooves 121, and in actual use, luminous bulb assemblies or LED assemblies can be further installed in the mounting grooves 121;
when using this embodiment, the user only needs to press the switch button 13 on the housing 11 to turn on/off the lamp beads 151 installed on the light-emitting elements 15 inside the housing 11 by means of a matching circuit module on the control panel 14 after the MCU chip 141 on the control panel 14 receives a matching electrical signal, and by means of the switch button 13, can further adjust the brightness and color of the lamp beads 151 and switch the light modes, such as an outdoor warning mode (red/yellow light flashes, or red/yellow light is always on) and an outdoor sports mode (multi-color lights flash alternately or are always on to add ambience); and
(the above circuit and driving method for controlling switching on/off of multi-color lamp beads, light brightness and color adjustment, and light mode switching and use by means of the MCU chip both belong to the prior art, and will not be described in detail here).

Finally, it should be noted that: first, in the description of the present disclosure, it should be noted that unless expressly specified and defined otherwise, the terms “mounting”, “connection”, “connected”, etc. are to be construed broadly and, for example, may also refer to a mechanical connection or an electrical connection, communication inside two elements or a direct connection; the terms “upper”, “lower”, “left”, “right” and the like are only used to indicate the relative positional relationship, and when an absolute position of an object being described changes, the relative positional relationship may change;

Second, in the accompanying drawings of the disclosed embodiments of the present disclosure, only the structures related to the disclosed embodiments are involved, usual designs can be referred to for other structures, and under the condition of no conflict, the same embodiment of the present disclosure and different embodiments can be combined mutually; and

Finally, the above are merely preferred embodiments of the present disclosure, and are not intended to limit the present disclosure. Any modifications, equivalent replacements and improvements made within the spirit and principle of the present disclosure should fall within the protection scope of the present disclosure.

What is claimed is:

1. A luminous helmet, comprising a main body (1), wherein a housing (11) is arranged above the main body (1), the housing (11) is made of a semitransparent or transparent material, and at least one switch button (13) is arranged on the housing (11);
a lining (12) is arranged below the housing (11), one or more mounting grooves (121) of any shape are formed in a surface part of the lining (12), light-emitting elements (15) are installed in the plurality of mounting grooves (121), and lamp beads (151) are welded to the light-emitting elements (15);
the lamp beads (151) are arranged to be multi-color LED lamp beads;
the number of the lamp beads (151) is one or more;
a slot (122) is further formed on the lining (12), a control panel (14) and a storage battery (16) are installed in the slot (122), and the storage battery (16) is installed under the control panel (14);
an upper surface of the control panel (14) is provided with a MCU chip (141); and
the switch button (13), the light-emitting elements (15) and the battery (16) are all electrically connected to the MCU chip (141) on the control panel (14), and by pressing the switch button (13), the lamp beads (151) on the light-emitting elements (15) can be switched on and off, color and brightness of light can be adjusted, and light modes can be switched.

2. The luminous helmet according to claim 1, wherein the switch button (13) is configured to be one of a touch switch, a push switch, a hydraulic switch or a knob switch.

3. The luminous helmet according to claim 1, wherein the mounting grooves (121) on the lining (12) are specifically arranged vertically, horizontally or obliquely.

4. The luminous helmet according to claim 1, wherein the main body (1) may be configured as a structure of any shape.

5. The luminous helmet according to claim 1, wherein the switch button (13) can be further arranged on either side of a bottom surface part or the surface part of the housing (11).

6. The luminous helmet according to claim 1, wherein the switch button (13) can be further arranged on either side of the surface part or the bottom surface part of the lining (12).

7. The luminous helmet according to claim 1, wherein both the control panel (14) and the storage battery (16) are both in fit with the slot (122).

8. The luminous helmet according to claim 1, wherein the lamp beads (151) can be further configured as single-color LED lamp beads.

9. The luminous helmet according to claim 1, wherein the light-emitting elements (15) can be further embedded on the surface part of the housing (11) or on either side of the bottom surface part of the housing (11).
